(19) United States
(12) Patent Application Publication
(10) Pub. No.: US 2024/0426105 A1
(43) Pub. Date: Dec. 26, 2024

(54) FIBER REINFORCED POLYMER AND METAL DUCTILITY FUSE FOR REINFORCING CONCRETE MEMBERS

(71) Applicant: Kansas State University Research Foundation, Manhattan, KS (US)

(72) Inventor: Hayder A. Rasheed, Manhattan, KS (US)

(21) Appl. No.: 18/687,858

(22) PCT Filed: Aug. 31, 2022
(86) PCT No.: PCT/US2022/042114

§ 371 Date: Feb. 29, 2024

Related U.S. Application Data
(60) Provisional application No. 63/238,825, filed on Aug. 31, 2021.

(51) Int. Cl. E04C 5/07; B32B 7/027; B32B 7/12; B32B 15/08; B32B 15/18

(52) U.S. Cl. CPC E04C 5/07; B32B 7/027; B32B 7/12; B32B 15/08; B32B 15/18; B32B 2250/03; B32B 2262/101; B32B 2307/30; B32B 2307/718

(57) ABSTRACT

Multi-component devices for reinforcing and/or strengthening concrete members that comprise both fiber reinforced polymer materials and metallic materials. The multi-component devices may be in the form of a layered structure in which one or more smaller metallic plates are sandwiched between layers of the same or different fiber reinforced polymer sheets. Alternatively, the multi-component devices may comprise metallic and fiber reinforced polymer rods fastened together, which may be embedded within new concrete structures as major reinforcement.

### CROSS-REFERENCE TO RELATED APPLICATION

This Application claims the benefit of U.S. Provisional Patent Application No. 63/238,825, filed Aug. 31, 2021, which is incorporated by reference herein in its entirety.

### BACKGROUND OF THE INVENTION

### Field of the Invention

Embodiments of the present invention are directed toward multi-component devices for reinforcing and/or strengthening concrete members that comprise both fiber reinforced polymer materials and metallic materials. The fiber reinforced polymer materials offer corrosion resistance, while the smaller metallic component provides for ductility at critical regions only within the concrete structure.

### Description of the Prior Art

The civil infrastructure in many parts of the world is aging and deteriorating. Replacing these aging and deteriorating buildings and bridges is a costly, but often necessary, solution due to the deterioration of concrete, corrosion of steel support elements, and the increase in truck weights over highway bridges. Therefore, research into how to extend the useful life of these structures is ongoing and economically important. Repair and strengthening of these aging and deteriorating structures through the external bonding of steel plates to the full tension side of concrete beams was introduced in the early 1980's. Research has shown that the system works in providing both extra strength and ductility to the strengthened beams. However, this technology did not make it to practice for two main reasons. Steel plates are prone to corrosion when exposed to the environment and they are very heavy to handle during on-site installation.

In 1987, Prof. Ur Meier from Switzerland proposed the use of carbon fiber reinforced polymer composites (CFRPs) to replace steel plates in strengthening concrete beams by external bonding. This solution has overcome the two short comings of the steel plates since CFRP is corrosion resistant and very light weight while it has very high stiffness and strength. The technology has succeeded to prove effective and move to practice all over the world. However, CFRP is known to be brittle at failure and has led to brittle failures of strengthened beams. The standard acceptable and desirable practice is to have ductile failures in structures especially in seismic zones. The other shortcoming of CFRP is the mismatch in its coefficient of thermal expansion compared to concrete and steel making the issue of long-term bond sustainability questionable. Furthermore, the very high modulus of CFRP yields another mismatch in stiffness with the concrete of the substrate promoting premature debonding of the CFRP preventing the utilization of the full material properties. Also, CFRP is known to have a very high cost and to be chemically conductive promoting more possible corrosion.

The materials commercially available for strengthening are Carbon FRP, Glass FRP, Aramid FRP, and Basalt FRP. Even though Glass FRP is much more affordable than Carbon FRP, earlier research studies recommended the use of Carbon FRP because of its higher stiffness and strength. However, the major drawbacks of using Carbon FRP are:
1. Thermal incompatibility with concrete and steel.
2. The lack of ductility to give a warning sign prior to failure.
3. High cost.
4. Chemically conductive properties.

To resolve these four issues, Glass FRP is known to be a thermally compatible material with concrete and steel when oriented along the fiber direction. It is also resistant to corrosion and chemically nonconductive. However, it is also known to be a brittle material at failure but more deformable than Carbon FRP by having a much higher strain to failure. Steel, on the other hand, provides the needed ductility but it is easily susceptible to corrosion and heavy in weight. Accordingly, a need exists in the art for an affordable solution that takes advantage of the desirable properties of steel and CFRP, but still provides the needed concrete strengthening characteristics.

### SUMMARY OF THE INVENTION

According to one embodiment of the present invention, there is provided a multicomponent device for strengthening of concrete structures. The device comprises a first layer comprising a fiber reinforced polymer sheet, a second layer comprising at least one metallic plate, and a third layer comprising the same or a different fiber reinforced polymer sheet as the first layer. The first, second, and third layers are adhered together to form the multicomponent device. Preferably, the first and third layers are full-size layers, whereas the second layer comprises at least one smaller-size metallic plate.

According to another embodiment of the present invention, there is provided a method of strengthening a concrete structure comprising securing to a portion of the concrete structure a multicomponent device according to any embodiment described herein.

According to yet another embodiment of the present invention, there is provided a multicomponent assembly for reinforcing of concrete structures. The multicomponent assembly comprises a first element comprising a metallic rod, and a second element comprising a fiber reinforced polymer rod. The first and second members are secured together to form the multicomponent assembly.

According to still another embodiment of the present invention, there is provided a method of reinforcing a concrete structure comprising securing to a portion of a concrete structure a multicomponent assembly according to any embodiment described herein.

### BRIEF DESCRIPTION OF THE DRAWINGS

FIG. 1 is a photograph of a typical steel cage for use in a concrete support structure;

FIG. 2 is a photograph of a steel cages placed within concrete formwork;

FIG. 3 is a photograph of concrete casting in a beam and cylinders;

FIG. 4 is a photograph depicting failure of a concrete control beam;

FIG. 5 is a chart depicting the load-deflection curve for the control beam;

FIG. 6 is a photograph of the failure of a concrete beam strengthened with a glass fiber reinforced polymer-steel fuse system according to an embodiment of the present invention;

FIG. 7 is a chart depicting the load-deflection curve for the GFRP-steel system;

FIG. 8 is a photograph depicting the failure of a comparative concrete beam reinforced with another glass fiber reinforced polymer-steel fuse system according to an embodiment of the present invention;

FIG. 9 is a chart depicting the load-deflection curve for the second GFRP-steel system;

FIG. 10 is a chart overlaying the curves of FIGS. 5 and 7;

FIG. 11 is a chart overlaying the curves of FIGS. 5 and 9;

FIG. 12 is a chart overlaying the response curves of a previous CFRP system and the control showing the lack of ductility of the CFRP system;

FIG. 13 schematically illustrates a concrete-reinforcing FRP-steel fuse device according to an embodiment of the present invention;

FIG. 14 schematically illustrates a concrete-reinforcing device configured to be embedded in concrete comprising a metallic rod fastened to a fiber reinforced polymer rod; and

FIG. 15 is a photograph depicting a steel cage comprising a concrete-reinforcing device in accordance with FIG. 14.

While the drawings do not necessarily provide exact dimensions or tolerances for the illustrated components or structures, the drawings are to scale with respect to the relationships between the components of the elements illustrated in the drawings.

### DETAILED DESCRIPTION OF THE PREFERRED EMBODIMENT

Embodiments of the present invention provide for a localized hybrid system that overcome the limitations of reinforcing members comprised only of FRP or steel. One or more embodiments of the present invention provide for improved ductility, that is light-weight, and has resistance to corrosion.

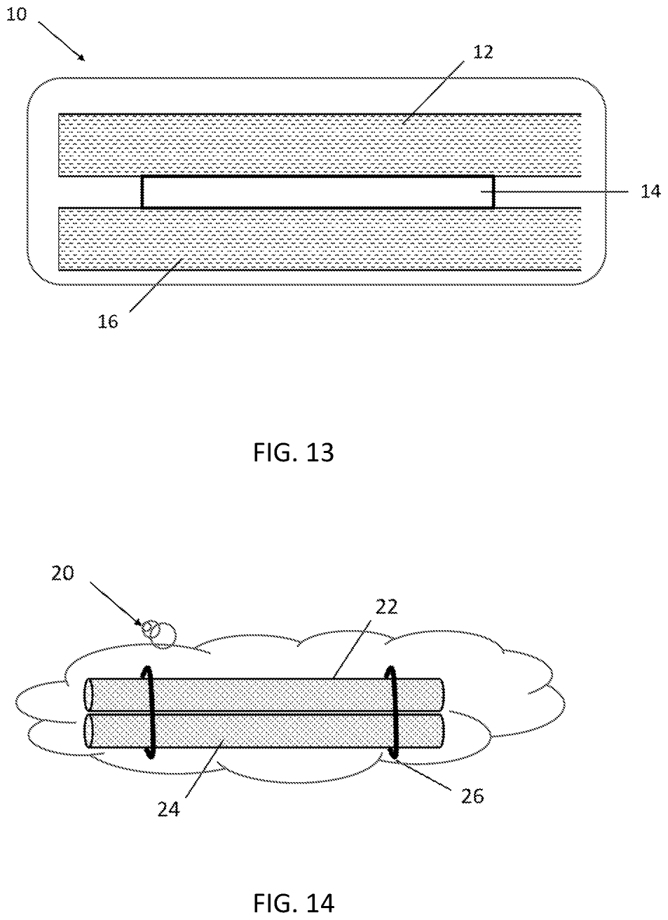

Turning first to FIG. 13, a multicomponent device 10 for strengthening of concrete structures is illustrated. The multicomponent device 10 comprises a first layer 12 comprising a fiber reinforced polymer sheet, a second layer 14 comprising at least one, preferably smaller-size, metallic plate, and a third layer 16 comprising the same or a different fiber reinforced polymer sheet as the first layer. In one or more embodiments, the fiber reinforced polymer sheet preferably comprises a glass fiber reinforced polymer sheet. However, it is also within the scope of the present invention for the fiber reinforced polymer sheet to comprise an aramid FRP, a basalt FRP, and/or a carbon FRP. In one or more embodiments, the metallic plate comprises steel; however, any metallic plate having sufficient structural characteristics for reinforcing concrete can be used, like aluminum alloy, titanium alloy or metal matrix composite (MMC) or combinations thereof.

The multicomponent device 10 can be easily assembled without requiring complex fabricating equipment. In one or more embodiments, the device 10 can be formed by sandwiching the various layers together. In one particular embodiment, an adhesive, such as a thermosetting structural epoxy adhesive, can be used to adhere the FRP sheets to the metallic plate. In an alternate embodiment, the FRP sheets can be overlaid onto the metallic plate and then heat applied to the system where the metallic part acts as a heat sink causing the polymer within the FRP sheet to cure at a higher temperature and bond with the metal plate better. This will result in a higher glass transition temperature (Tg) making this device more heat resistant. However, any manufacturing technique capable of causing the layers to adhere together to form a unitary structure that resists delamination can be used.

In one or more embodiment, each of fiber reinforced polymer sheets 12, 16 has a coefficient of thermal expansion that is within 10%, within 8%, or within 5% of a coefficient of thermal expansion for the at least one metallic plate.

In one or more embodiments, the fiber reinforced polymer sheets 12, 16 have a modulus of elasticity of from 50 to 100 kN/mm², from 60 to 90 kN/mm², or from 70 to 80 kN/mm². In one or more embodiments, the fiber reinforced polymer sheets 12, 16 have a tensile strength of from 2750 to 4500 N/mm², from 3000 to 4000 N/mm², or from 3250 to 3750 N/mm². In one or more embodiments, the fiber reinforced polymer sheets 12, 16 have a sheet weight of from 325 to 475 g/m², from 350 to 450 g/m², or from 375 to 425 g/m², in main direction. In one or more embodiments, the fiber reinforced polymer sheets 12, 16 have a density of from 1.75 to 3.5 g/cm³, from 2.0 to 3.0 g/cm³, or from 2.25 to 2.75 g/cm³.

In one or more embodiments, the combined weight of the first and third layers 12, 16 making up device 10 is less than 50%, less than 60%, less than 70%, or less than 80% of the weight of the second layer 14. In addition, as can be seen in FIG. 13, layers 12, 16 can be much larger than, and envelope layer 14. This feature permits device 10 to be constructed to only require the metallic plate to be specifically configured as needed for a particular application. In one or more embodiments, at least one of the first and third layers 12, 16 (and preferably both) comprise major faces that have a surface area that is greater than the surface area of the major faces of the at least one metallic plate 14. Thus, by permitting metallic plate 14 to be much smaller than either of layers 12, 14, device 10 can be constructed to be light weight, making installation upon the concrete structure to be reinforced much easier.

Device 10 can be used to strengthen a concrete structure such as a bridge, pier, column, building foundation, or support beam, by securing the device to a portion of the structure requiring reinforcement. The portion requiring reinforcement could be a result of age or other deterioration of the concrete making up the structure. However, it is also within the scope of the present invention for device 10 to be installed to a newly fabricated structure as a prophylactic measure to prevent deterioration. Device 10 can be secured to the concrete structure using various fasteners known in the art, including bolts and anchors.

In certain embodiments, device 10 is particularly suited for use to externally reinforce or strengthen structures in seismically active regions in which the structure, or at least portions thereof, require a certain level of ductility. In such embodiments, the metallic plate 14 is placed at the critical location so the structure, such as the plastic hinge regions, to provide ductility by yielding only at these locations while the FRP sheets 12, 16 provide continuity of stress transfer throughout the rest of the strengthened member surface. Therefore, in one embodiment, device 10 is secured to the structure such that at least a portion of the metallic plate 14 is located in covering relationship to at least a portion of the plastic hinge of the structure. As understood in the art, the term “plastic hinge” is used to describe the deformation of a section of a reinforced concrete flexural member where plastic bending occurs. In earthquake engineering, “plastic hinge” can also be a type of energy dissipating device allowing plastic rotation of an otherwise rigid column connection. In certain embodiments, portions of layers 12, 16 can extend beyond the margins of the plastic hinge region of the structure that the metallic plate 14 overlies.

In another embodiment of the present invention, the concepts described above can be applied to reinforcing members that are embedded within new concrete structures. As shown in FIG. 14, a multicomponent assembly 20 is provided that includes a first element comprising a metallic rod 22, and a second element comprising a fiber reinforced polymer rod 24. The rods 22, 24 are secured together, such as with one or more wraps or fasteners (e.g., a plastic or metal strap) 26. Thus, the rods, 22, 24 are positioned adjacent to and abut each other when embedded within the concrete structure to act together as one piece.

The FRP rods have similar advantages to the FRP sheets described above. They are corrosion resistant, but brittle in response. By tying the FRP rod 24 to a metallic rod 22, especially a steel rod, the metallic rod acts as a ductility fuse. While the metallic rod 22 is not protected against corrosion, it is embedded in the concrete. Even if the assembly 20 is used in applications with an aggressive corrosion environment, a part of the ductility fuse will remain intact after suffering corrosion and offer the ductility needed resulting from failure of the structure or in response to a seismic event.

In one or more embodiments, the metallic rod 22 has a smaller diameter than the FRP rod 24. In one or more embodiments, the metallic rod 22 may have a length that is less than the length of the FRP rod 24. Like device 10 described above, the metallic rod 22 may have a coefficient of thermal expansion that is within 10%, 8%, or 5% of a coefficient of thermal expansion for the FRP rod.

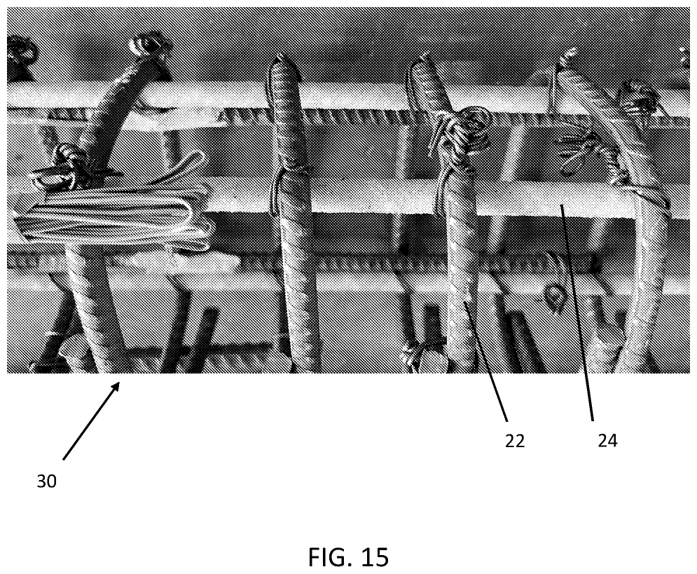

In addition, it is noted that assembly 20 may comprise a plurality of members 22 and 24. In certain embodiments, a single rod 22 and multiple rods 24 may be provided. Alternatively, multiple rods 22 and a single rod 24 may be provided. The rods can be arranged in various configurations, such as a single rod 22 surrounded by multiple rods 24, and vice-versa. In one or more embodiments, one or more FRP rods 24 can be connected to the metallic rods 22 that form part of a steel cage 30 such as depicted in FIG. 15. The FRP rods 24 can be oriented longitudinally relative to the cage structure and secured to steel rods 22 that are parallel or perpendicular to the FRP rods 24.

As indicated above, assembly 20 can be used to reinforce a concrete structure by embedding the assembly within the concrete structure during fabrication. In one or more embodiments, at least a portion of the metallic rod 22 is embedded within the concrete structure in a location that corresponds with a plastic hinge of the concrete structure.

Embodiments of the present invention, especially embodiments like device 10, can be used to construct other structures such as infill walls in seismic regions. Device 10 can be constructed to form two skins of the wall, with the metallic plate(s) being embedded between layers 12, 16 only at locations of plastic hinges. A honeycomb or foam core may be added to such walls as a nonstructural filler in order to reduce the cost of the wall.

### EXAMPLES

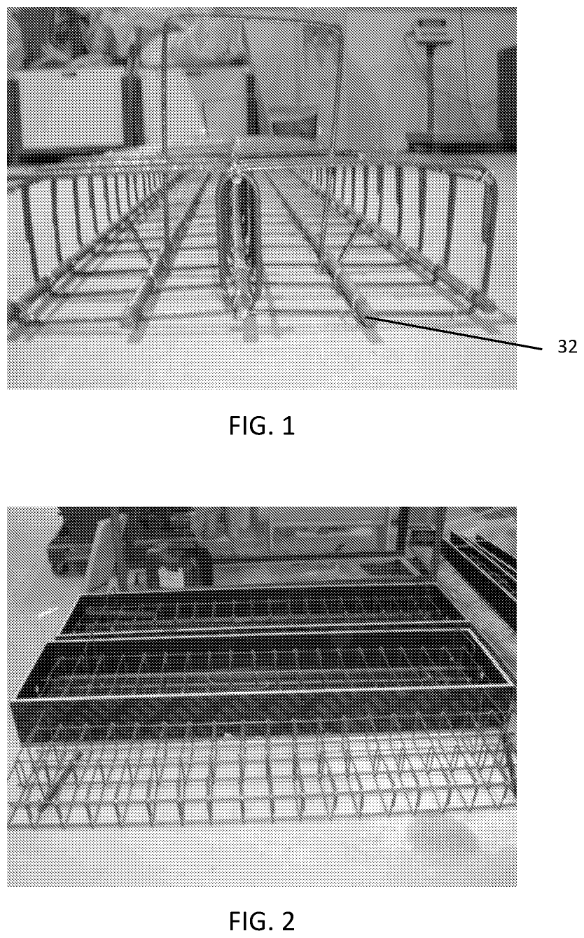

Three wide beam specimens were designed, fabricated, casted and tested. The beams were 19.69 in wide by 7.87 in deep by 6.56 ft long (500 mm wide by 200 mm deep by 2000 mm long). They were reinforced with 5 No. 4 bars 32 (see, FIG. 1) (12.5 mm nominal diameter or 11.7 mm actual diameter) bottom reinforcement having a yield strength of 83.6 ksi (576 MPa) and 3 No. 3 bars (10 mm nominal diameter or 9.8 mm actual diameter) top reinforcement as shown in FIG. 1-2. The yield strength of rebars was obtained by testing 11.8 in (300 mm) bar coupon with a gage length of 7.87 in (200 mm).

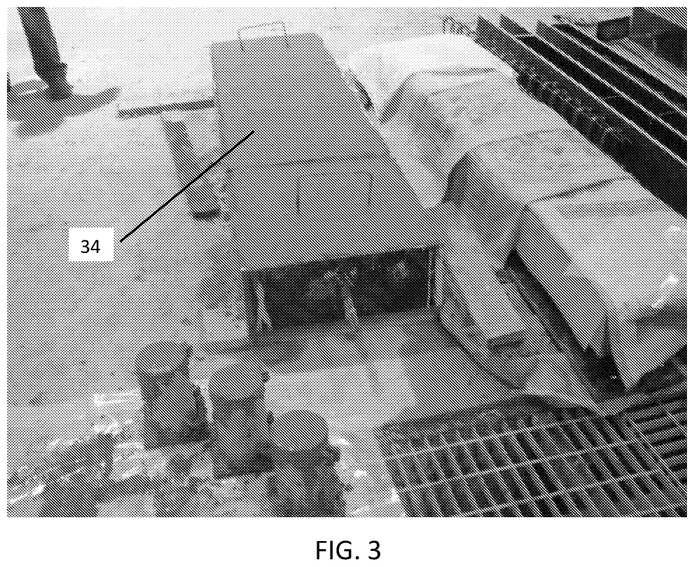

The three beams 34 were cast simultaneously using ready mix concrete and were cured by water spraying for the first 28 days. Three 4 in by 8 in (100 mm by 200 mm) concrete cylinders were prepared and cast alongside with the beams to determine the concrete strength at 7 and 28 days. See, FIG. 3. The crushing load for the cylinders was 122 kN after 7 days (15.5 MPa) and an average of 180 kN after 28 days (22.9 MPa).

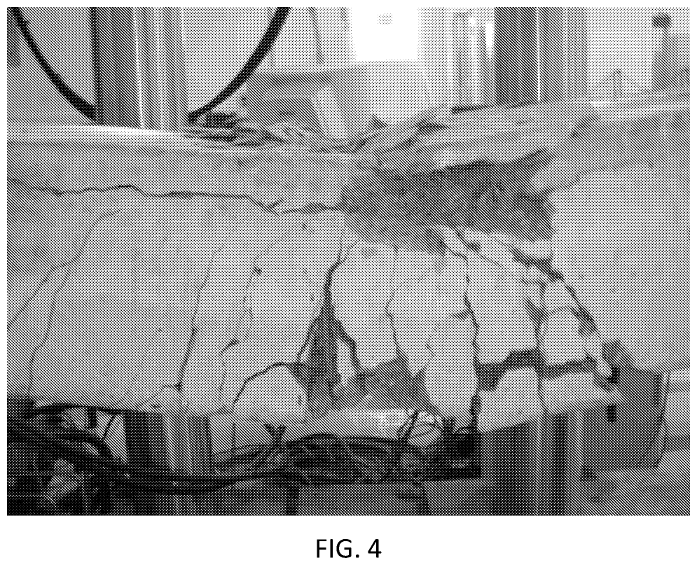

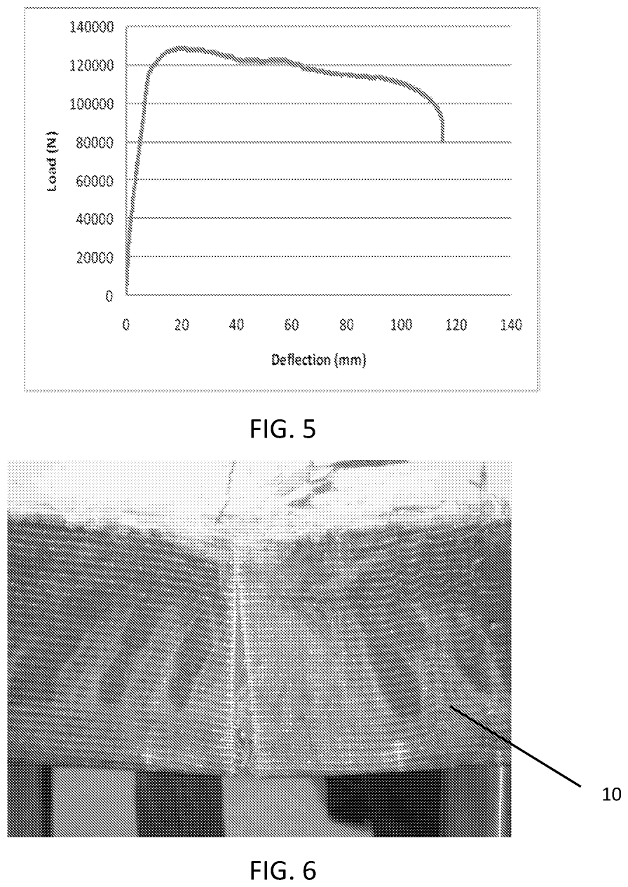

The control beam was tested without any strengthening to establish the baseline behavior and performance as well as to benchmark the results of the sandwich GFRP-Steel fuse-GFRP system. The control beam was tested in three point bending and it behaved as expected and failed in a ductile flexural mode of yielding of primary reinforcement followed by crushing of the top concrete at mid-span. FIG. 4 shows a close up of the failure of the specimen and FIG. 5 shows a plot of the load-deflection diagram of this beam (beam 1) up to the final collapse of the member.

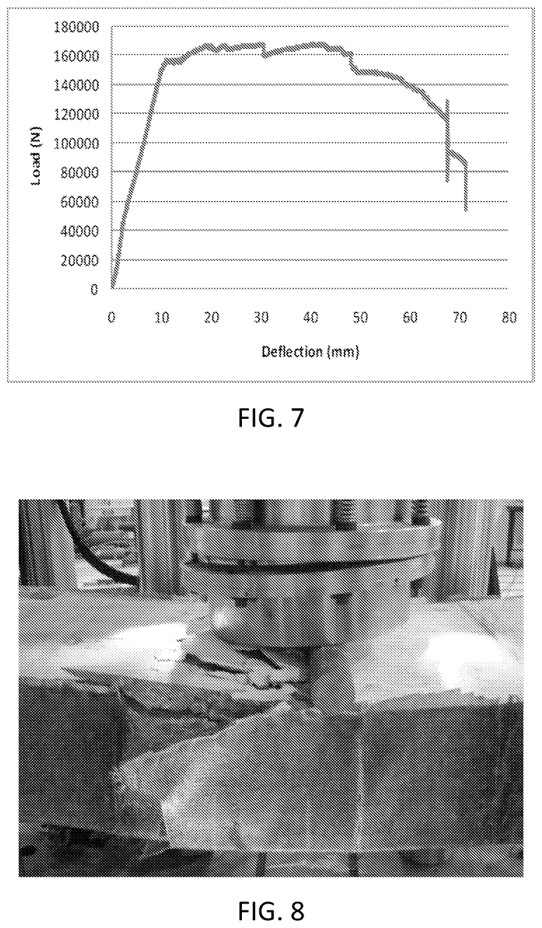

The other two beams were strengthened with the new hybrid GFRP-Steel fuse-GFRP system. The GFRP sheets used were MBrace G Sheet E 90/10 A materials made by BASF. Two-part structural epoxy manufactured by BASF was used to saturate the GFRP and adhere it to the steel fuse. The width of the beam is 500 mm. However, it was determined by analysis that only 250 mm wide GFRP and a smaller steel plate can be applied and securely anchored by GFRP U-Wraps to ensure the development of the full flexural capacity without any premature delamination failure that is brittle in nature. The design calculations indicated the need to fully wrap the beam with 2 layers of GFRP. Accordingly, Beam 2 was strengthened with 2 layers of 250 mm flexural GFRP sheets extending all the way to the supports sandwiched with a small steel fuse plate of 250 mm width by 1000 mm length applied only at the critical location of the maximum bending moment region. At the termination points of the steel plate the shear stress concentration would be typically high but the existence of the GFRP sheets on both surfaces help in transferring the axial stress smoothly and avoid any shear stress concentration at the steel plate tip. Beam 2 succeeded in developing a 30% increase in flexural capacity over the control beam. More importantly, the failure was completely ductile and flexural based with no separation or delamination of the strengthening system or the anchoring system (U-Wraps). FIG. 6 shows the beam at failure which is evident to be confined together by the GFRP even after undergoing significant ductile deformations by yielding the internal steel and the steel fuse plate ending with crushing of concrete in compression. FIG. 7 shows the ductile load deflection curve of the GFRP-Steel fuse-GFRP hybrid system.

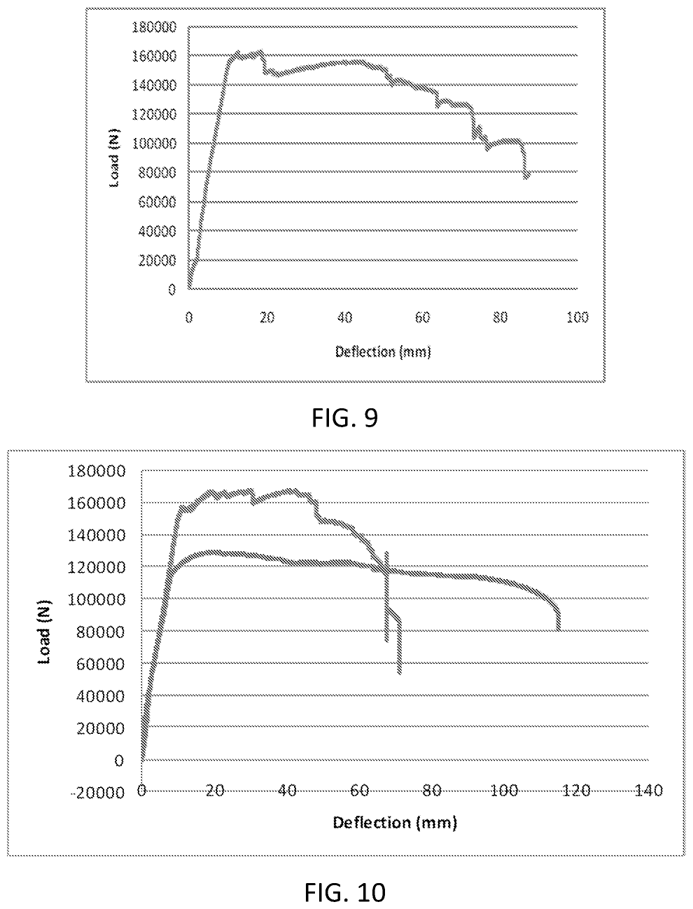

Beam 3 was also strengthened with 2 layers of 250 mm flexural GFRP sheets extending all the way to the supports sandwiched with a smaller steel fuse plate of 200 mm width by 500 mm length applied only at the critical location of the maximum bending moment region. At the termination points of the steel plate the shear stress concentration would also be high but the existence of the GFRP sheets help in transferring the axial stress smoothly and avoid any shear stress concentration at the steel plate tip. Beam 3 succeeded in developing a 30% increase in flexural capacity over the control beam as well. More importantly, the failure was completely ductile and flexural based with some separation or delamination of the anchoring system (U-Wraps) because this system did not completely wrap the beam and there was a small area of concrete seam in between the U-Wraps. FIG. 8 shows the beam at failure which is evident to be confined together by the GFRP even after undergoing significant ductile deformations by yielding the internal steel and the steel fuse plate ending with crushing of concrete in compression. FIG. 9 shows the ductile load deflection curve of the GFRP-Steel fuse-GFRP hybrid system.

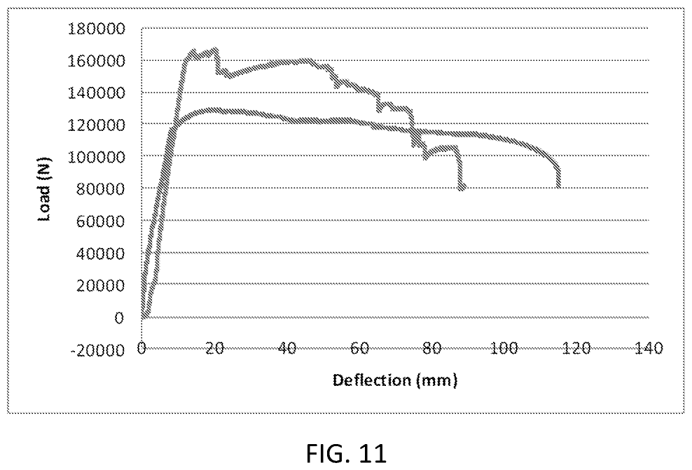

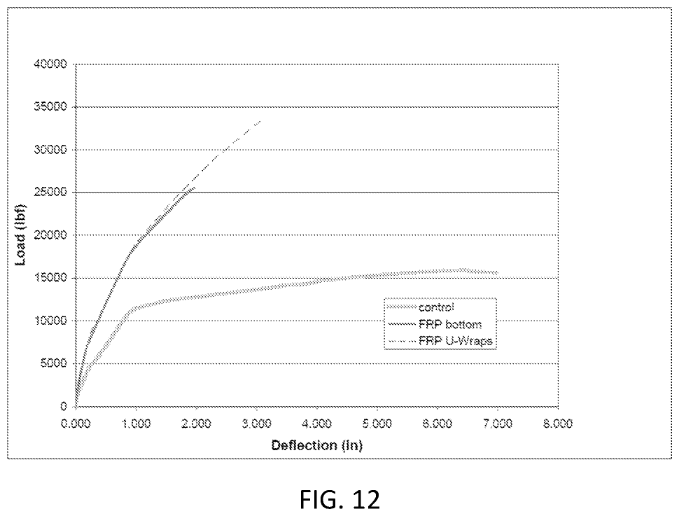

FIGS. 7 and 9 clearly show the significant ductility of the new strengthening system compared to the control beam which is very ductile as well. To get the comparison in perspective, the response of the two strengthened beams is directly compared to the baseline control specimen response in one graph, FIGS. 10 and 11. To further clarify the difference between this new ductile system and the state-of-the-art CFRP system, the response of a CFRP system that failed in flexure and tested by the inventor, in a different study, is compared to the response of its control beam in FIG. 12 showing no real ductility. The new system is protected against corrosion by the presence of the GFRP sandwich. The new system has a very close coefficient of thermal expansion to that of steel and concrete while it is very affordable compared to the state-of-the-art CFRP.

The previous description is provided by way of illustration and should not be taken as a limitation upon the overall scope of the invention.

1. A multicomponent device for strengthening of concrete structures comprising:
a first layer comprising a fiber reinforced polymer sheet;
a second layer comprising at least one metallic plate; and
a third layer comprising the same or a different fiber reinforced polymer sheet as the first layer,
wherein the first, second, and third layers are adhered together to form the multicomponent device, and wherein the metallic plate is smaller in size than the first and third layers.

2. The multicomponent device of claim 1, wherein the first and third layers comprise glass fiber reinforced polymer sheets, wherein the second layer comprises a steel plate, and wherein the first and third layers are adhered to the second layer with an adhesive.

3. (canceled)

4. The multicomponent device of claim 1, wherein each of the fiber reinforced polymer sheets has a coefficient of thermal expansion that is within 10% of a coefficient of thermal expansion for the at least one metallic plate.

5. The multicomponent device of claim 1, wherein the combined weight of the first and third layers is less than 50% of the weight of the second layer.

6. (canceled)

7. The multicomponent device of claim 1, wherein at least one of the first and third layers comprise major faces that have a surface area that is greater than the surface area of the major faces of the at least one metallic plate.

8. A method of externally strengthening a concrete structure comprising securing to a portion of a concrete structure a multicomponent device comprising:
a first layer comprising a fiber reinforced polymer sheet;
a second layer comprising at least one metallic plate; and
a third layer comprising the same or a different fiber reinforced polymer sheet at the first layer,
wherein the first, second, and third layers are adhered together to form the multicomponent device.

9. The method of claim 8, wherein the first and third layers comprise glass fiber reinforced polymer sheets, and the second layer comprises a steel plate.

10. The method of claim 8, wherein each of the fiber reinforced polymer sheets has a coefficient of thermal expansion that is within 10% of a coefficient of thermal expansion for the at least one metallic plate.

11. The method of claim 8, wherein the multicomponent device is secured to the structure such that at least a portion of the steel plate is located in covering relationship to at least a portion of the plastic hinge of the structure.

12. A multicomponent assembly for internally reinforcing of concrete structures comprising:
a first element comprising a metallic rod; and
a second element comprising a fiber reinforced polymer rod,
wherein the first and second elements are secured together to form the multicomponent assembly.

13. The multicomponent assembly of claim 12, wherein the metallic rod is a steel rod, and wherein the fiber reinforced polymer rod comprises a glass fiber reinforced polymer rod.

14. (canceled)

15. The multicomponent assembly of claim 12, wherein the first element has a smaller diameter than the second element, and wherein the first element has a length that is less than a length of the second element.

16. The multicomponent assembly of claim 12, wherein the metallic rod has a coefficient of thermal expansion that is within 10% of a coefficient of thermal expansion for the fiber reinforced polymer rod.

17. (canceled)

18. The multicomponent assembly of claim 12, wherein the first and second elements are secured together with a wrap or fastener.

19. The multicomponent assembly of claim 12, wherein the assembly comprises a plurality of the first and second elements.

20. A method of internally reinforcing a concrete structure comprising embedding within a portion of a concrete structure a multicomponent assembly comprising:
a first element comprising a metallic rod; and
a second element comprising a fiber reinforced polymer rod,
wherein the first and second elements are secured together to form the multicomponent assembly.

21. The method of claim 20, wherein the metallic rod is a steel rod, and wherein the fiber reinforced polymer rod comprises a glass fiber reinforced polymer rod.

22. The method of claim 20, wherein the first element has a smaller diameter than the second element.

23. The method of claim 20, wherein the metallic rod has a coefficient of thermal expansion that is within 10% of a coefficient of thermal expansion for the fiber reinforced polymer rod.

24. The method of claim 20, wherein at least a portion of the first member is embedded within the concrete structure in a location that corresponds with a plastic hinge of the concrete structure.
